(19) United States
(12) Patent Application Publication
(10) Pub. No.: US 2004/0043849 A1
(43) Pub. Date: Mar. 4, 2004

(54) Transmission using flat gear

(76) Inventor: Cheol-Soo Kim, Busan-city (KR)

Correspondence Address: NIXON & VANDERHYE, PC, 1100 N GLEBE ROAD, 8TH FLOOR, ARLINGTON, VA, 22201-4714, US

(21) Appl. No.: 10/415,007

(22) PCT Filed: Oct. 23, 2001
(86) PCT No.: PCT/KR01/01785

(30) Foreign Application Priority Data
Oct. 24, 2000 (KR) 200063636
Mar. 15, 2001 (KR) 200114453
Jun. 26, 2001 (KR) 200138576
Sep. 24, 2001 (KR) 200159030

(51) Int. Cl. F16H 9/10

(52) U.S. Cl. 474/53

(57) ABSTRACT

A transmission using a flat gear and a grooved flat gear is provided. The transmission includes a flat gear having a speed stage constituted by a predetermined number of grooves formed in a circle on a circular plate or a grooved flat gear having a plurality of speed stages constituted by a predetermined number of grooves formed in concentric circles on a circular plate in a rotary direction and an open groove which is common to the plurality of speed stages. Accordingly, a single flat gear or grooved flat gear is perpendicularly coupled to at least one bevel gear disposed at a power shaft for power transmission and speed change, thereby solving the problems of contamination of a coating due to lubricant, derailment of a chain, or irregular transmission time occurring in a chain type transmission. In addition, as compared to a gear box type transmission using spur gears, the weight and size of the transmission is decreased and the efficiency of power transmission is increased, thereby simplifying the structure of the transmission and reducing the manufacturing cost and malfunction rate.

### TECHNICAL FIELD

The present invention relates to a power transmission device or transmission for transmitting power using a gear, and more particularly, to a power transmission device or transmission with a flat gear or a grooved flat gear in which grooves are formed in concentric circles on a circular plate and a circle of the grooves constitutes a single speed stage.

### BACKGROUND ART

In a conventional power transmission device or transmission, a chain moves between sprockets to perform power transmission or speed change, so derailment of the chain, irregular transmission time, or contamination of a coating due to lubricant may occur during power transmission. In addition, as for a gear box type transmission made by combining spur gears, an increase in the number of gears causes the entire weight and size of the transmission to increase and complicates implementation of the transmission.

### DISCLOSURE OF THE INVENTION

To solve the above-described problems, it is an object of the present invention to provide a flat gear or grooved flat gear in which grooves are formed on a circular plate, and a transmission using the gear.

To achieve the above object of the invention, in a first embodiment, there is provided a flat gear including a circular plate made of a predetermined material, a predetermined number of grooves formed in concentric circles on the circular plate, and a plurality of speed stages constituted by the grooves formed in the concentric circles on the circular plate.

In a second embodiment, there is provided a grooved flat gear including a plurality of speed stages constituted by a predetermined number of grooves formed in concentric circles on a circular plate in a rotary direction, and an open groove which is common to the plurality of speed stages.

In a third embodiment, there is provided a transmission including a flat gear comprising at least two speed stages constituted by a predetermined number of grooves formed in at least two concentric circles on a circular plate, as many bevel gears as the number of the speed stages of the flat gear, each bevel gear being perpendicularly coupled to the flat gear, and a spline unit coupled to the bevel gears for power transmission.

In a fourth embodiment, there is provided a transmission including a grooved flat gear comprising at least two speed stages and an open groove common to the speed stages in a radial direction, a bevel gear perpendicularly coupled to a groove of one of the speed stages of the grooved flat gear, and a spline unit coupled to the bevel gear for power transmission.

### BRIEF DESCRIPTION OF THE DRAWINGS

The above objects and advantages of the present invention will become more apparent by describing in detail a preferred embodiment thereof with reference to the attached drawings in which:

FIG. 1 is a plan view of a flat gear having three speed stages constituted by grooves which are formed in concentric circles on a circular plate according to the present invention;

FIG. 2 is a plan view of a grooved flat gear having a common open groove to speed stages constituted by grooves which are formed in concentric circles on a circular plate according to the present invention;

FIG. 3 is a diagram of a bevel gear which engages with a flat gear or a grooved flat gear according to the present invention;

FIG. 4 is a diagram of a spline unit which is coupled to a bevel gear to transmit the power of a flat gear or a grooved flat gear according to the present invention;

FIG. 5 shows a front view and a left side view of the spline unit of FIG. 4;

FIG. 6A is a diagram in which a flat gear is perpendicularly coupled to a power shaft by a bevel gear according to the present invention;

FIG. 6B is a perspective view of a fixing plate for fixing bevel gears which transmit power generated by a flat gear to a power shaft according to the present invention;

FIG. 6C is a sectional view in which bevel gears for transmitting power generated by a flat gear to a power shaft are coupled to a fixing plate for fixing the bevel gears according to the present invention;

FIG. 7 is a diagram of a transmission in which a grooved flat gear is coupled to a power shaft to change a speed according to the present invention; and

FIG. 8 is a perspective view of a device for transmitting power or changing a speed using a flat gear according to the present invention.

### BEST MODE FOR CARRYING OUT THE INVENTION

Hereinafter, preferred embodiments of the present invention will be described in detail with reference to the attached drawings.

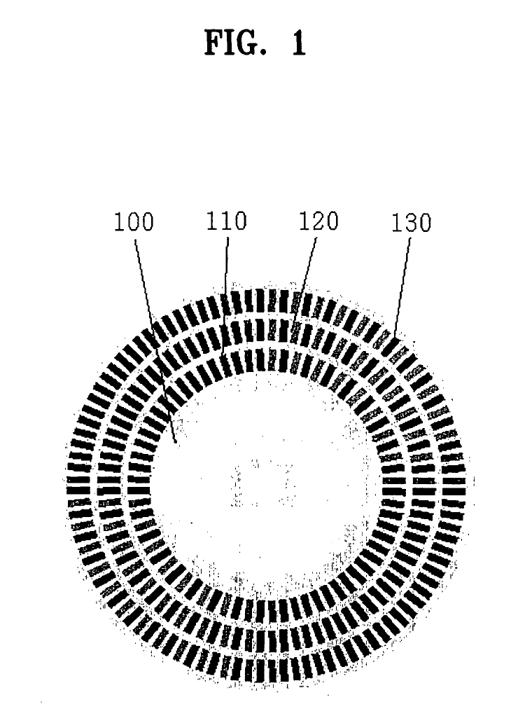

FIG. 1 is a plan view of a flat gear having three speed stages constituted by grooves which are formed in concentric circles on a circular plate according to the present invention. A flat gear 100 has a plurality of speed stages constituted by grooves formed in concentric circles on a circular plate. In the embodiment shown in FIG. 1, there are three speed stages. The three speed stages are implemented by a low speed part 110, a medium speed part 120, and a high speed part 130. A speed part for higher speed has more grooves. The grooves of the flat gear 100 all have the same size and shape and have the same shape as the tooth form of a bevel gear so that the grooves can linearly contact the bevel gear, so the grooves can transmit the same torque when the flat gear 100 perpendicularly engages the bevel gear.

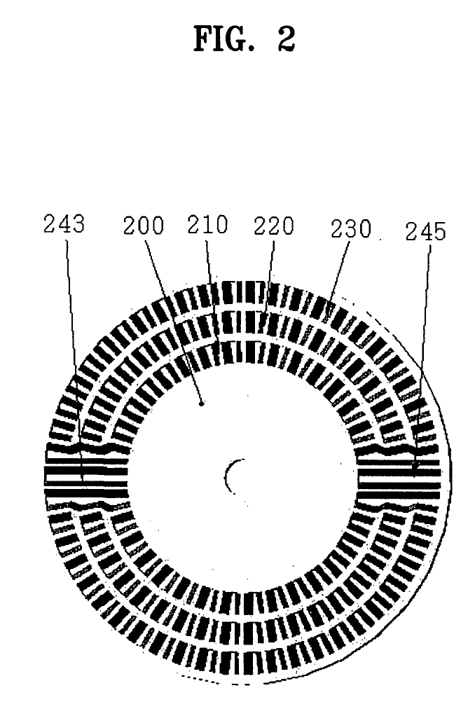

FIG. 2 is a plan view of a grooved flat gear having three speed stages constituted by grooves which are formed in concentric circles on a circular plate and having an open groove common to grooves positioned on a line passing through the center of the circular plate in the speed stages according to the present invention. A grooved flat gear 100 includes three speed stages implemented by a low speed part 210, a medium speed part 220, and a high speed part 230, and open grooves 243 and 245 common to all three speed stages.

The open grooves 243 and 245 are paths through which a bevel gear perpendicularly coupled to the grooves of the grooved flat gear 200 to transmit the torque of the grooved flat gear 200 slides from one speed stage to another speed stage. For example, when a bevel gear coupled to the grooves of the low speed part 210 is shifted to a high or medium speed, the bevel gear slides along the open grove 243 or 245 to accomplish the shift.

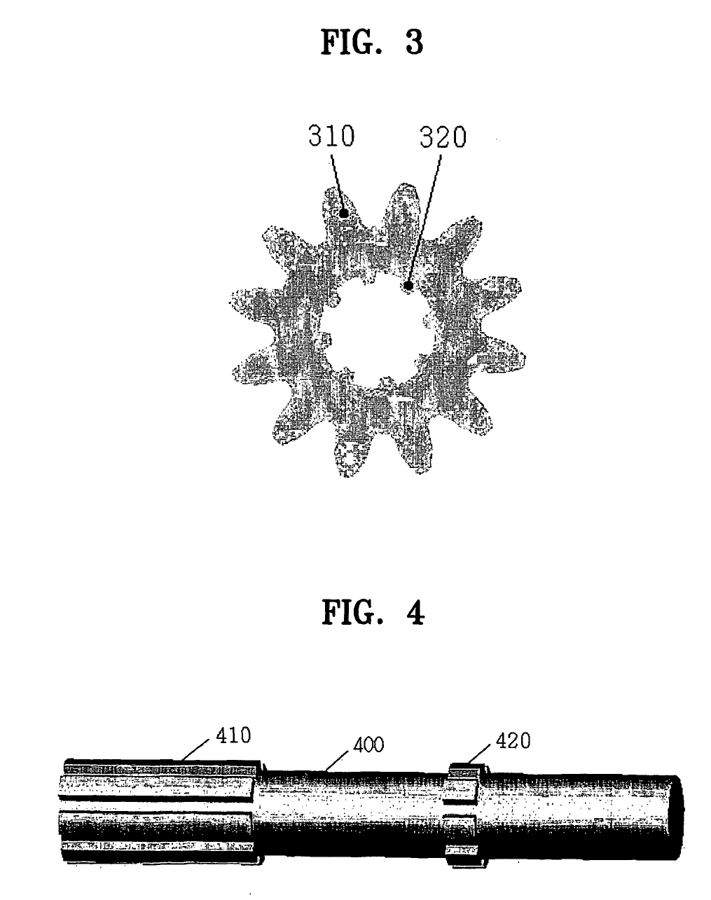

FIG. 3 is a diagram of a bevel gear which engages with a flat gear or a grooved flat gear according to the present invention. The bevel gear has the same module as each groove of a flat gear or a grooved flat gear shown in FIGS. 1 or 2. A tooth form 310 of the bevel gear is coupled to a groove of a flat gear or a grooved flat gear, thereby transmitting torque. A spline protrusion 320 has a function of spline coupling the bevel gear to a power shaft transmitting the power of a gear.

FIG. 4 is a diagram of a spline unit 400 which couples to a bevel gear to transmit the power of a flat gear or a grooved flat gear according to the present invention. The spline unit 400 includes a long spline groove 410 and a short spline groove 420.

The spline unit 400 is coupled to a flat gear 100 such that the long spline protrusion 410 is coupled to a power shaft and the short spline protrusion 420 is coupled to one of as many bevel gears as the number of speed stages the flat gear 100 has. When the spline unit 400 moves in the radial direction of the flat gear 100, the short spline protrusion 420 is coupled to a bevel gear coupled to one speed stage of the flat gear 100, thereby performing transmission of torque.

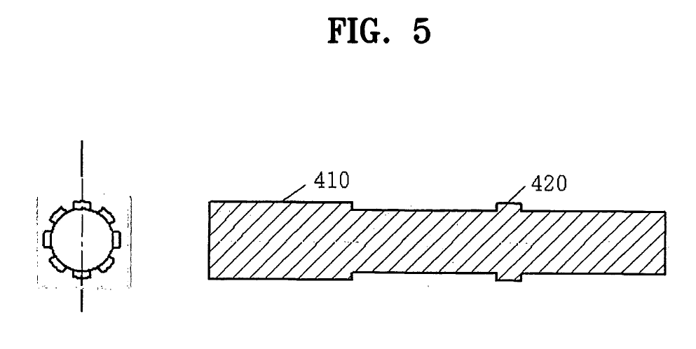

FIG. 5 shows a front view and a left side view of the spline unit 400 of FIG. 4. When the flat gear 100 is used for power transmission, the long spline protrusion 410 is coupled to a power shaft and the short spline protrusion 420 is coupled to a bevel gear. When the grooved flat gear 200 is used for power transmission, the long spline protrusion 410 is coupled to a bevel gear and the short spline protrusion 420 is coupled to a power shaft.

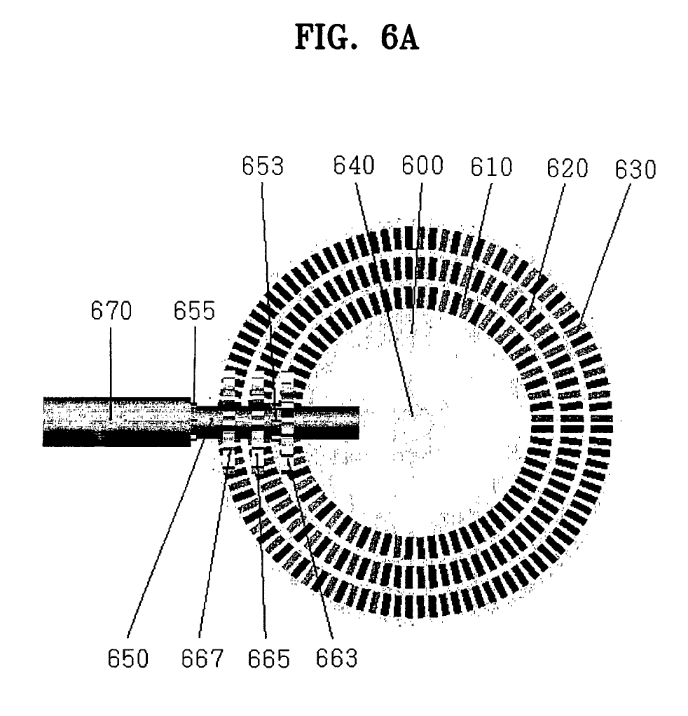

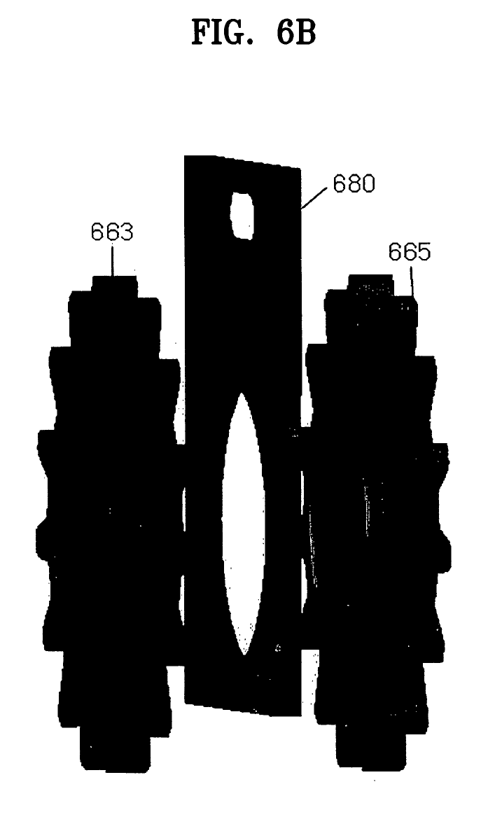

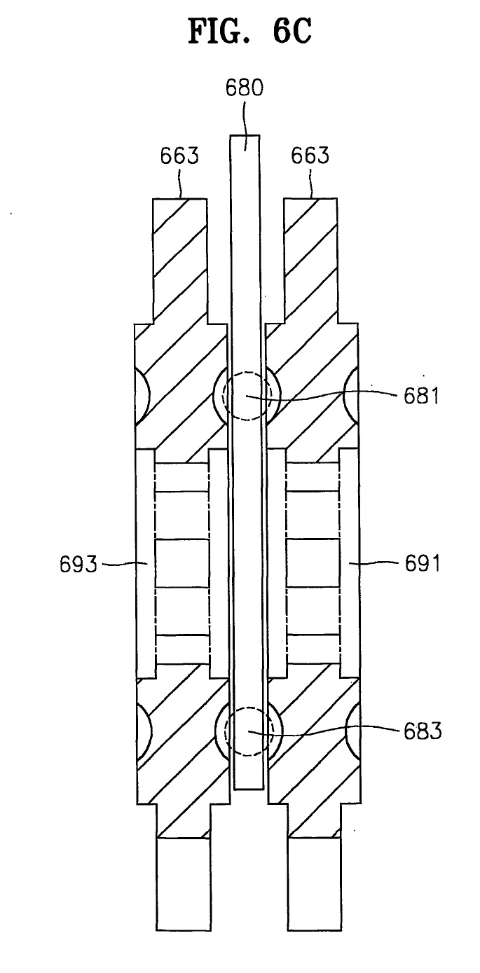

FIG. 6A is a diagram in which a flat gear is perpendicularly coupled to a power shaft by a bevel gear according to the present invention. A flat gear 600 has three speed stages constituted by grooves formed in concentric circles on a circular plate. The speed stages are implemented by a low speed part 610, a medium speed part 620, and a high speed part 630.

Once the flat gear 600 is rotated by a driving shaft 640, bevel gears 663, 665, and 667 perpendicularly coupled to grooves of the flat gear 600 rotate, and one of the bevel gears 663, 665, and 667 is coupled to a short spline protrusion 653 of a spline unit 650, thereby transmitting torque to a power shaft 670. The power shaft 670 is coupled to the spline unit 650 through the long spline protrusion 655. In an example of power transmission, when low speed torque is transmitted to the power shaft 670 in a state in which the low speed bevel gear 663 is coupled to the low speed part 610 of the flat gear 600, the spline unit 650 is moved so that the high speed bevel gear 667 can be coupled to the short spline protrusion 653 in order to changing a speed. As a result, high speed torque can be transmitted to the power shaft 670. Here, when one bevel gear is coupled to the short spline protrusion 653, the remaining two bevel gears rotate without transmitting torque. A method of fixing the three bevel gears 663, 665, and 667 will be described with reference to FIGS. 6B and 6C.

FIG. 6B is a perspective view of a fixing plate for fixing bevel gears which transmit power generated by a flat gear to a power shaft according to the present invention. FIG. 6C is a sectional view in which bevel gears for transmitting power generated by a grooved flat gear to a power shaft are coupled to a fixing plate for fixing the bevel gears according to the present invention.

In a method of fixing the two bevel gears 663 and 665, a fixing plate 680 is inserted between the two bevel gears 663 and 665, and the bevel gears 663 and 665 have ball keeping grooves 681 and 683. A ball is pressed and inserted between the ball keeping grooves 681 and 683 and fixed by the fixing plate 680 so that the bevel gears 663 and 665 can rotate independently. Spline grooves 691 and 693 are used for fixing the bevel gears 663 and 665 to a spline unit. If three speed stages are set, three bevel gears are fixed as described above so that torque can be transmitted to a power shaft.

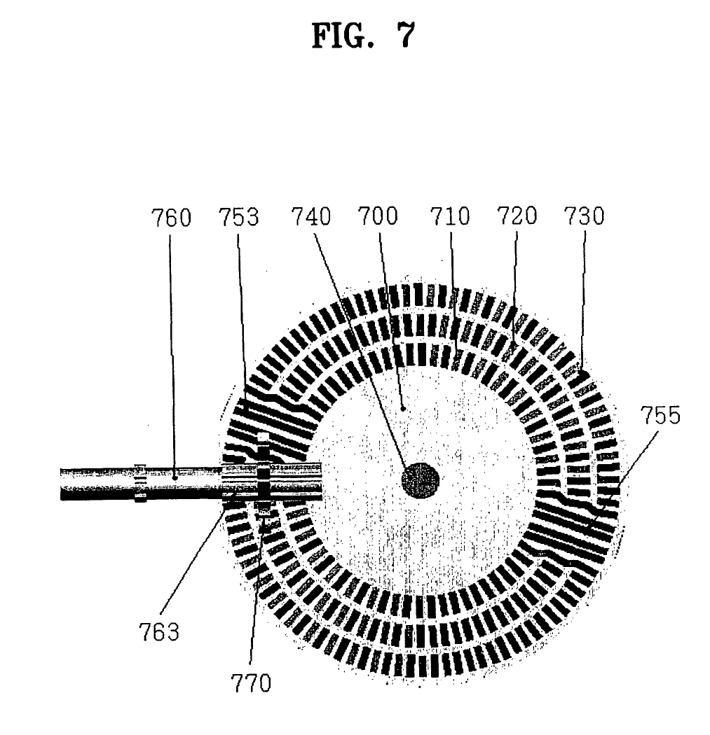

FIG. 7 is a diagram of a transmission in which a grooved flat gear is coupled to a power shaft to change a speed according to the present invention. The grooved flat gear has three speed stages and an open groove common to the three speed stages so that a bevel gear can move to change a speed.

A grooved flat gear 700 includes speed stages implemented by a low speed part 710, a medium speed part 720, and a high speed part 730, and open grooves 753 and 755 common to the three speed stages. The grooved flat gear 700 is perpendicularly coupled to a bevel gear 770, and the bevel gear 770 is coupled to a spline unit 760 through a spline protrusion 763, so the torque of the grooved flat gear 700 is transmitted.

For the transmission of torque, a driving shaft 740 generates torque to thus rotate the grooved flat gear 700. As a result, the bevel gear 770 coupled to one of the low speed part 710, the medium speed part 720, and the high speed part 730 of the grooved flat gear 700 rotates. When changing a speed, the bevel gear 770 slides along one of the open groves 753 and 755 to one of the speed stages, i.e., the low speed part 710, the medium speed part 720, and the high speed part 730, when the bevel gear 770 engages one of the open grooves 753 and 755.

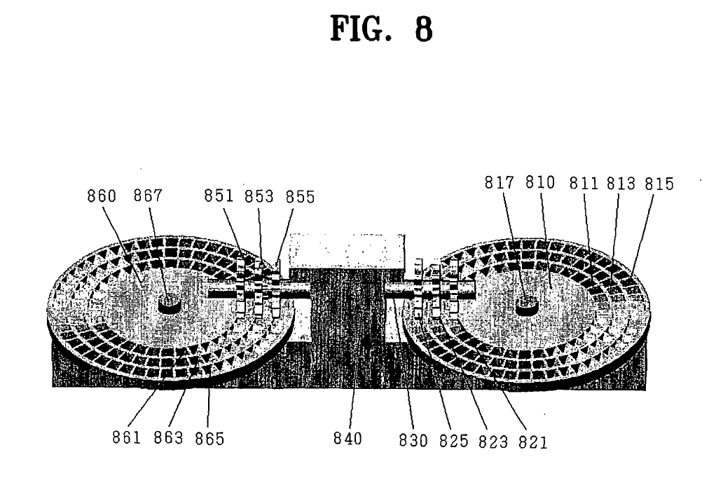

FIG. 8 is a perspective view of a device for transmitting power or changing a speed using a flat gear according to the present invention. Two flat gears are coupled to a power shaft for transmission of torque.

A driving flat gear 810 and a driven flat gear 860 are connected by a power shaft 830. The power shaft 830 is fixed to a frame by a power shaft support 840. Three bevel gears 821, 823, and 825 are spline coupled to the driving side of the power shaft 830, and three bevel gears 851, 853, and 855 are spline coupled to the driven side of the power shaft 830.

Once torque is generated by a driving shaft 817, the driving flat gear 810 rotates, and the torque of the driving flat gear 810 is transmitted to the driven side through the power shaft 830 which is spline coupled to the low speed bevel gear 821, the medium speed bevel gear 823, or the high speed bevel gear 825 coupled to a low speed part 811, a medium speed part 813, or a high speed part 815 to transmit the torque.

The driven side receives the torque from the low speed bevel gear 851, the medium speed bevel gear 853, or the high speed bevel gear 855 which is perpendicularly coupled to a low speed part 861, a medium speed part 863, or a high speed part 865 of the driven flat gear 860 according to a rotary speed. As a result, the driving flat gear 860 rotates, and the torque is transmitted through a driven shaft 867.

According to the present invention, a flat gear, a grooved flat gear, or a bevel gear is made of high strength plastic, which decreases the entire weight of a transmission, thereby increasing the efficiency of power transmission.

Industrial Applicability

As described above, according to the present invention, a single flat gear or grooved flat gear is perpendicularly coupled to at least one bevel gear disposed at a power shaft for power transmission and speed change, thereby solving the problems of contamination of a coating due to lubricant, derailment of a chain, or irregular transmission time occurring in a conventional chain type transmission. In addition, as compared to a gear box type transmission using spur gears, the present invention decreases the weight and size of a transmission and increases the efficiency of power transmission, thereby simplifying the structure of the transmission and reducing the manufacturing cost and malfunction rate.

What is claimed is:

1. A flat gear comprising:
a circular plate made of a predetermined material;
a predetermined number of grooves formed in concentric circles on the circular plate; and
a plurality of speed stages constituted by the grooves formed in the concentric circles on the circular plate.

2. The flat gear of claim 1, comprising at least two speed stages constituted by a predetermined number of grooves formed in at least two concentric circles on the circular plate.

3. A grooved flat gear comprising:
a plurality of speed stages constituted by a predetermined number of grooves formed in concentric circles on a circular plate in a rotary direction; and
an open groove which is common to the plurality of speed stages.

4. A transmission comprising:
a flat gear comprising at least two speed stages constituted by a predetermined number of grooves formed in at least two concentric circles on a circular plate;
as many bevel gears as the number of the speed stages of the flat gear, each bevel gear being perpendicularly coupled to the flat gear; and
a spline unit coupled to the bevel gears for power transmission.

5. The transmission of claim 4, wherein the spline unit comprises a spline for coupling with the bevel gears and moves in a radial direction of the flat gear to be coupled to one of the bevel gears for transmission of torque.

6. The transmission of claim 4, wherein the spline unit is connected to another spline unit through a rotary power shaft, thereby coupling at least two transmissions.

7. A transmission comprising:
a grooved flat gear comprising at least two speed stages and an open groove common to the speed stages in a radial direction;
a bevel gear perpendicularly coupled to a groove of one of the speed stages of the grooved flat gear; and
a spline unit coupled to the bevel gear, the spline unit moving the bevel gear along the open groove of the grooved flat gear so that the bevel gear is perpendicularly coupled to one of the speed stages.

8. The transmission of claim 7, wherein the spline unit is connected to another spline unit through a rotary power shaft, thereby coupling at least two transmissions.
